(19) United States
(12) Patent Application Publication
(10) Pub. No.: US 2026/0088039 A1
(43) Pub. Date: Mar. 26, 2026

(54) APPARATUS AND METHOD USING JOINT OF DISCRETE EMOTIONAL REPRESENTATION AND DIMENSIONAL EMOTIONAL REPRESENTATION FOR SPEECH EMOTION RECOGNITION

(71) Applicant: Electronics and Telecommunications Research Institute, Daejeon (KR)

(72) Inventors: John Lorenzo BAUTISTA, Daejeon (KR); HyunSoon SHIN, Daejeon (KR); Yun Kyung LEE, Daejeon (KR)

(73) Assignee: Electronics and Telecommunications Research Institute, Daejeon (KR)

(21) Appl. No.: 19/308,548

(22) Filed: Aug. 25, 2025

(30) Foreign Application Priority Data
Sep. 20, 2024 (KR) 10-2024-0127036

(51) Int. Cl. G10L 25/63; G10L 25/18; G10L 25/24; G10L 25/30

(52) U.S. Cl. CPC G10L 25/63; G10L 25/18; G10L 25/24; G10L 25/30

(57) ABSTRACT

Disclosed is a speech emotion recognition apparatus. The speech emotion recognition apparatus includes a processor. The processor generates result data derived from a speech signal using an artificial neural network model. The artificial neural network model includes an encoder layer, an attention layer, and an output layer. The encoder layer outputs a plurality of latent features based on the speech signal and a pre-processed signal obtained by preprocessing the speech signal. The attention layer outputs attention data by applying a self-attention mechanism and a co-attention mechanism to the plurality of latent features. The output layer outputs the result data including probability values associated with discrete emotional representations and numerical values associated with dimensional emotional representations based on the attention data.

### CROSS-REFERENCE TO RELATED APPLICATIONS

This application claims priority under 35 U.S.C. § 119 to Korean Patent Application No. 10-2024-0127036 filed on Sep. 20, 2024, in the Korean Intellectual Property Office, the disclosure of which is incorporated by reference herein in its entirety.

### BACKGROUND

Embodiments of the present disclosure described herein relate to speech emotion recognition, and more particularly, relate to a speech emotion recognition apparatus and a speech emotion recognition method using a joint of discrete emotional representation and dimensional emotional representation.

Speech emotion recognition (SER) analyzes speech signals to recognize speaker's emotions. The traditional approach with respect to the speech emotion recognition is to classify the speaker's emotions into preset categories to obtain discrete emotional representations. However, this traditional approach tends to oversimplify the complex and continuous characteristics of human emotions. To solve this problem, a joint model is emerging that analyzes speech signals to obtain not only discrete emotional representations but also dimensional emotional representations.

### SUMMARY

Embodiments of the present disclosure provide a speech emotion recognition apparatus that provides speech emotion recognition with improved performance.

Embodiments of the present disclosure provide a speech emotion recognition method using the speech emotion recognition apparatus.

According to an embodiment of the present disclosure a speech emotion recognition apparatus includes a processor. The processor generates result data derived from a speech signal using an artificial neural network model. The artificial neural network model includes an encoder layer, an attention layer, and an output layer. The encoder layer outputs a plurality of latent features based on the speech signal and a pre-processed signal obtained by preprocessing the speech signal. The attention layer outputs attention data by applying a self-attention mechanism and a co-attention mechanism to the plurality of latent features. The output layer outputs the result data including probability values associated with discrete emotional representations and numerical values associated with dimensional emotional representations based on the attention data.

According to an embodiment of the present disclosure, in a speech emotion recognition method using an artificial neural network model, a plurality of latent features are output based on a speech signal. Attention data are output by applying a self-attention mechanism and a co-attention mechanism to the plurality of latent features. Result data including probability values associated with discrete emotional representations and numerical values associated with dimensional emotional representations are output based on the attention data.

### BRIEF DESCRIPTION OF THE FIGURES

The above and other objects and features of the present disclosure will become apparent by describing in detail embodiments thereof with reference to the accompanying drawings.

FIG. 1 is a block diagram illustrating a speech emotion recognition apparatus, according to an embodiment of the present disclosure.

FIG. 2 is a flowchart illustrating an embodiment of a speech emotion recognition method using a speech emotion recognition apparatus of FIG. 1.

FIG. 3A is a diagram for describing a representative model related to discrete emotional representations, and FIG. 3B is a diagram for describing a representative model related to dimensional emotional representations.

FIG. 4 is a block diagram illustrating an embodiment of an artificial neural network model of FIG. 1.

FIG. 5 is a block diagram illustrating an embodiment of an encoder layer of FIG. 4.

FIG. 6 is a flowchart illustrating an embodiment of an operation of an encoder layer of FIG. 5.

FIG. 7 is a block diagram illustrating an embodiment of an attention layer of FIG. 4.

FIG. 8 is a flowchart illustrating an embodiment of an operation of an attention layer of FIG. 7.

FIG. 9 is a block diagram illustrating an embodiment of an output layer of FIG. 5.

FIG. 10 is a flowchart illustrating an embodiment of an operation of an output layer of FIG. 9.

FIG. 11 is a diagram for describing a joint loss function related to training of an artificial neural network model of FIG. 1.

FIG. 12 is a flowchart illustrating an embodiment of a process for training an artificial neural network model of FIG. 1 based on a joint loss function of FIG. 11.

FIG. 13 is a diagram for describing a process for updating a first coefficient of FIG. 11.

### DETAILED DESCRIPTION

Hereinafter, embodiments of the present disclosure will be described in detail and clearly to such an extent that an ordinary one in the art easily implements the present disclosure.

The terms “unit”, “module”, etc. to be used below and function blocks illustrated in drawings may be implemented in the form of a software component, a hardware component, or a combination thereof. Below, to describe the technical idea of the present disclosure clearly, a description associated with identical components will be omitted.

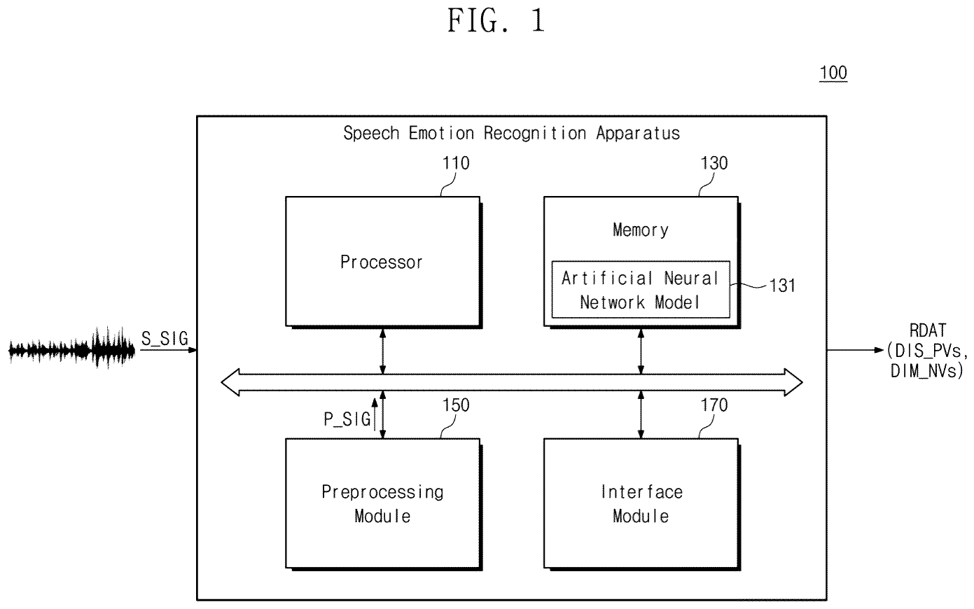

FIG. 1 is a block diagram illustrating a speech emotion recognition apparatus, according to an embodiment of the present disclosure.

Referring to FIG. 1, a speech emotion recognition apparatus 100 may be an electronic device that analyzes a speech signal of a speaker and recognizes the speaker's emotion. For example, the speech emotion recognition apparatus 100 may provide a single joint model architecture capable of identifying and understanding the speaker's emotion from a speech signal. For example, the speech emotion recognition apparatus 100 may enhance human-computer interaction (HCl) to enable applications such as mental health monitoring, customer service, entertainment, and education.

The speech emotion recognition apparatus 100 may include a processor 110, a memory 130, a preprocessing module 150, and an interface module 170. The memory 130 may store an artificial neural network model 131.

The processor 110 may control the components 130, 150, and 170 of the speech emotion recognition apparatus 100 in general, and may generate result data RDAT derived from a speech signal S_SIG using the artificial neural network model 131.

In an embodiment, the speech emotion recognition apparatus 100 may receive the speaker's speech signal S_SIG from the outside through the interface module 170, may control the preprocessing module 150 to generate a pre-processed signal P_SIG of a different form from the speech signal S_SIG, and may input the speech signal S_SIG and the pre-processed signal P_SIG into the artificial neural network model 131 to generate the result data RDAT.

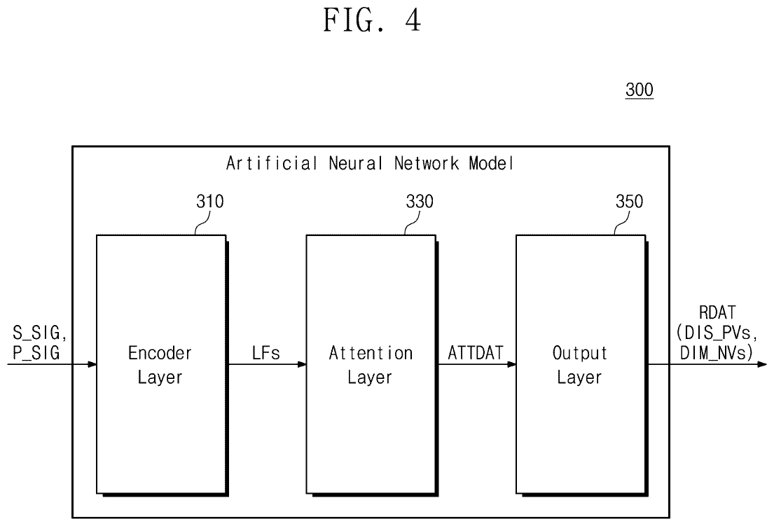

In an embodiment, the preprocessing module 150 may generate the pre-processed signal P_SIG based on the speech signal S_SIG. For example, the pre-processed signal P_SIG may include a frequency signal, a spectrum signal, and other various features related to the speech signal S_SIG. For example, the preprocessing module 150 may divide the speech signal S_SIG into short temporal segments to generate the pre-processed signal P_SIG, may perform a Fourier transform on the speech signal S_SIG, or may apply various analysis methods such as filtering. The speech signal and the pre-processed signal will be described later with reference to FIG. 4, etc.

In an embodiment, the artificial neural network model 131 may include a plurality of layers, may process the speech signal S_SIG and the pre-processed signal P_SIG in parallel, and may apply an attention mechanism to focus on a specific part of the speech signal S_SIG and the pre-processed signal P_SIG. For example, the artificial neural network model 131 may analyze and identify the relationship or interdependence between the speech signal S_SIG and the pre-processed signal P_SIG using the parallel processing and the attention mechanism, and may generate the result data RDAT. The artificial neural network model will be described later with reference to FIGS. 4 to 10.

In an embodiment, the result data RDAT may include probability values associated with discrete emotional representations and numerical values associated with dimensional emotional representations, and the probability values and the numerical values may comprehensively and accurately represent the rich complexity of the speaker's emotions.

In an embodiment, some or all of the plurality of layers included in the artificial neural network model 131 may be implemented using deep learning technology, may be learned based on a single joint loss function, and various weight schemes may be applied when generating the joint loss function. The learning of the artificial neural network model will be described later with reference to FIGS. 11, 12, and 13.

Through the above configuration, the speech emotion recognition apparatus according to the embodiments of the present disclosure may analyze and integrate the discrete and dimensional aspects of the speaker's emotion, and may represent the speaker's emotion as result data including probability values associated with discrete emotional representations and numerical values associated with dimensional emotional representations. The speech emotion recognition apparatus may improve the accuracy of speech emotion recognition by concatenating discrete emotional representations and dimensional emotional representations to provide a more comprehensive and subtle understanding with respect to the speaker's emotion. The speech emotion recognition apparatus may provide an integrated model architecture that enables simultaneous learning of a classification task related to the discrete emotional representations and a regression task related to the dimensional emotional representations, and may provide a comprehensive understanding with respect to the speaker's emotion and may improve interpretability by using the integrated model architecture.

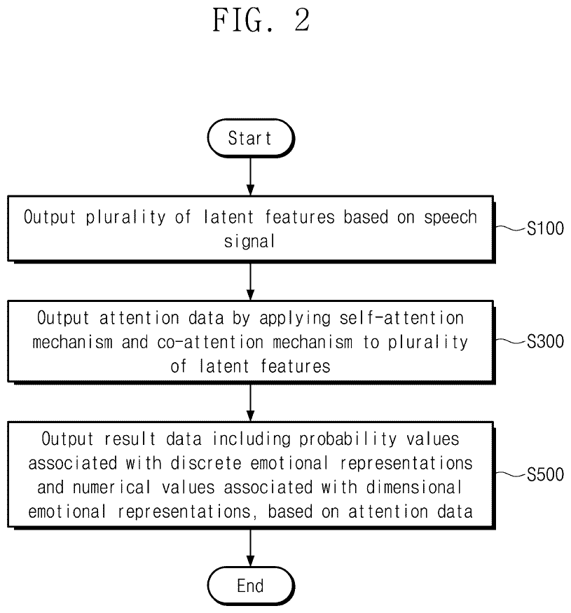

FIG. 2 is a flowchart illustrating an embodiment of a speech emotion recognition method using a speech emotion recognition apparatus of FIG. 1.

Referring to FIG. 2, in a speech emotion recognition method, a plurality of latent features may be output based on a speech signal (S100).

In an embodiment, a pre-processed signal may be generated based on the speech signal, and the plurality of latent features may be generated based on the speech signal and the pre-processed signal.

In an embodiment, the preprocessing module (e.g., 150 of FIG. 1) may generate the pre-processed signal based on the speech signal. For example, the preprocessing module may divide the speech signal into a plurality of segments to generate a short-term feature (STF), and may perform a Fourier transform on the speech signal to generate a frequency signal. The preprocessing module may generate a Mel-Spectrogram by applying a Mel Filter Bank to the frequency signal, and may generate MFCC (Mel-Frequency Cepstral Coefficients) by applying a Cepstral analysis to the Mel-Spectrogram.

Attention data may be output by applying a self-attention mechanism and a co-attention mechanism to the plurality of latent features (S300).

In an embodiment, the attention data may include information about the relationship or interdependence between the speech signal and the pre-processed signal.

Based on the attention data, result data including probability values associated with discrete emotional representations and numerical values associated with dimensional emotional representations may be output (S500).

In an embodiment, S100, S300, and S500 may be performed by the processor (e.g., 110 of FIG. 1), the artificial neural network model (e.g., 131 of FIG. 1) and the preprocessing module (e.g., 150 of FIG. 1). For example, the processor may control the preprocessing module and the artificial neural network model to perform S100, S300, and S500.

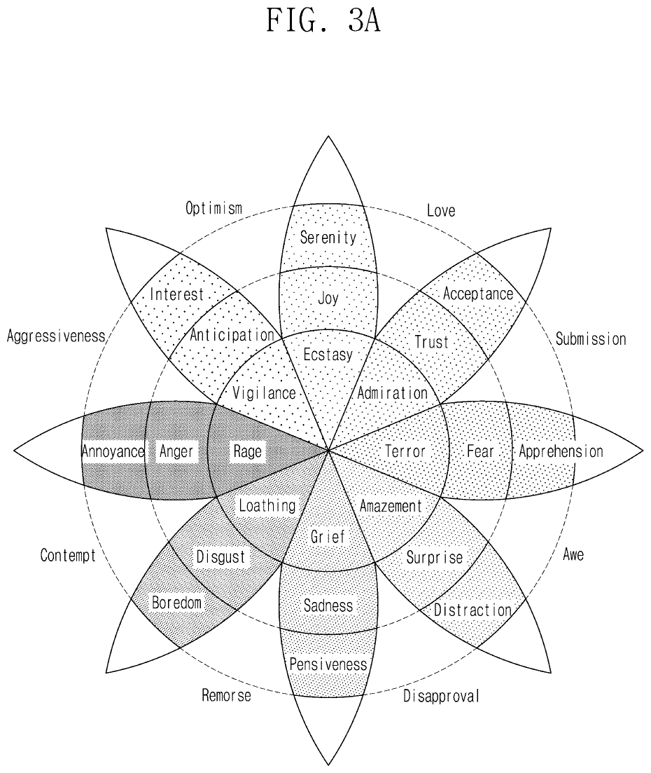

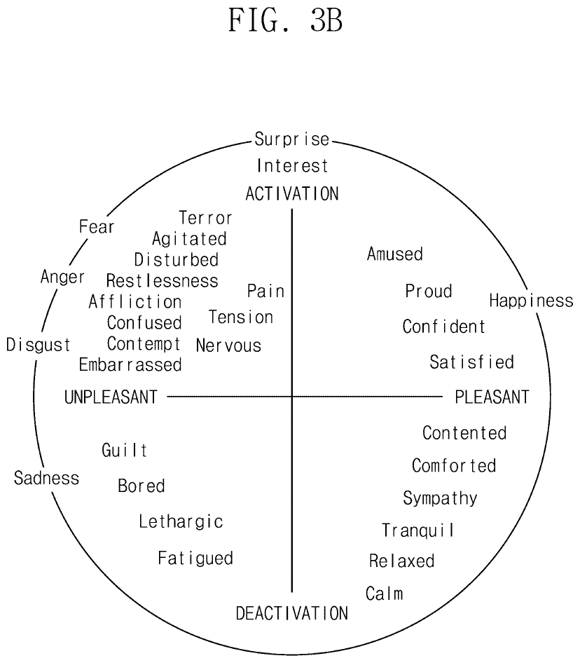

FIG. 3A is a diagram for describing a representative model related to discrete emotional representations, and FIG. 3B is a diagram for describing a representative model related to dimensional emotional representations.

In general, in speech emotion recognition, the speaker's emotional representation may be classified into two types: discrete and dimensional. In FIG. 3A, the wheel of emotions model suggested by Plutchik for discrete emotional representation in speech emotion recognition is illustrated, and in FIG. 3B, the dualistic model suggested by Russell for dimensional emotional representation is illustrated.

Referring to FIG. 3A, human emotions may be discretely represented using eight basic emotions: joy, trust, fear, surprise, sadness, disgust, anger, and anticipation.

Referring to FIG. 3B, human emotions may be represented as continuous dimensions in space along two basic axes: the degree (valence) of pleasantness/unpleasantness and the level of arousal.

Each of the two types of models representing human emotions according to FIGS. 3A and 3B has its own advantages and disadvantages, but when only one type is relied on, the accuracy of the joint model that attempts to provide a more comprehensive and subtle understanding with respect to the speaker's emotion may be ambiguous. Therefore, the speech emotion recognition apparatus and the speech emotion recognition method according to the embodiments of the present disclosure effectively combine the advantages of the discrete emotion representations and the dimensional emotion representations related to the speaker's emotion to present a new joint model that represents the speaker's emotion more comprehensively and accurately.

FIG. 4 is a block diagram illustrating an embodiment of an artificial neural network model of FIG. 1.

In FIG. 4, an artificial neural network model 300 may correspond to the artificial neural network model 131 of FIG. 1. Referring to FIG. 4, the artificial neural network model 300 may include an encoder layer 310, an attention layer 330, and an output layer 350.

The encoder layer 310 may output a plurality of latent features LFs based on the speech signal S_SIG and the pre-processed signal P_SIG.

In an embodiment, the encoder layer 310 may include a plurality of feature encoders, and may generate the plurality of latent features LFs by processing each of the speech signal S_SIG and the pre-processed signal P_SIG in parallel using the corresponding feature encoder. For example, some of the plurality of feature encoders may generate some of the plurality of latent features LFs based on the speech signal S_SIG, and others of the plurality of feature encoders may generate other some of the plurality of latent features LFs based on the pre-processed signal P_SIG.

The attention layer 330 may output attention data ATTDAT by applying a self-attention mechanism and a co-attention mechanism to the plurality of latent features LFs.

In an embodiment, the attention layer 330 may include a plurality of attention sub-layers, and each of the plurality of latent features LFs may be input to corresponding attention sub-layers to generate the attention data ATTDAT. For example, some of the plurality of attention sub-layers may correspond to each of the plurality of latent features LFs, and other some of the plurality of attention sub-layers may correspond to all of the plurality of latent features LFs.

The output layer 350 may output the result data RDAT including probability values DIS_PVs associated with discrete emotional representations and numerical values DIM_NVs associated with dimensional emotional representations based on the attention data ATTDAT.

In an embodiment, the output layer 350 may further include projection layers for projecting the attention data ATTDAT onto paths for generating the probability values DIS_PVs associated with the discrete emotional representations and the numerical values DIM_NVs associated with the dimensional emotional representations.

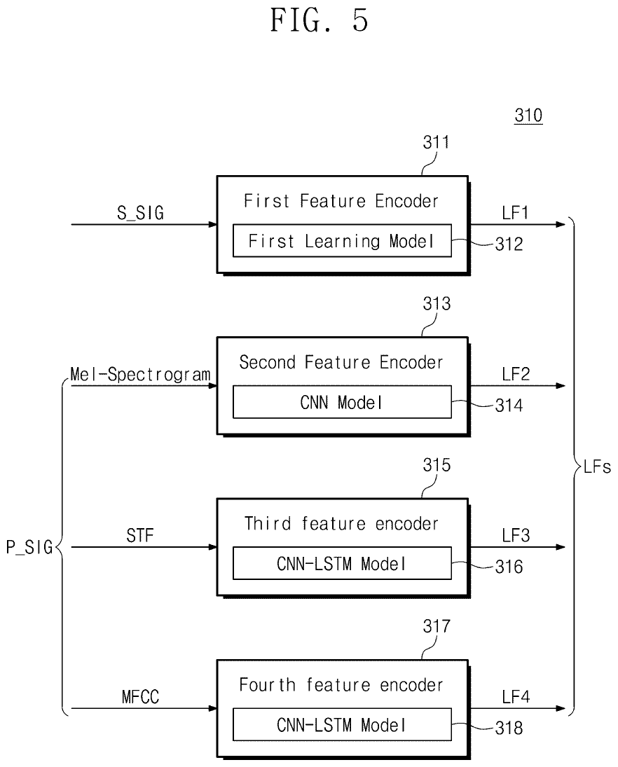

FIG. 5 is a block diagram illustrating an embodiment of an encoder layer of FIG. 4.

Referring to FIG. 5, the encoder layer 310 may include a first feature encoder 311, a second feature encoder 313, a third feature encoder 315, and a fourth feature encoder 317. In FIG. 5, an embodiment is illustrated in which the encoder layer 310 includes four feature encoders, but the number and types of feature encoders are only examples.

The pre-processed signal P_SIG may include a Mel-spectrogram, an STF (Short-Term Feature), and MFCC (Mel-Frequency Cepstral Coefficients) related to the speech signal S_SIG, but the scope of the present disclosure is not limited thereto.

Each of the first to fourth feature encoders 311, 313, 315, and 317 may output a corresponding part of the plurality of latent features LFs based on a corresponding signal among the speech signal S_SIG and the pre-processed signal P_SIG.

In an embodiment, the first feature encoder 311 may output a first latent feature LF1 based on the speech signal S_SIG, and the second feature encoder 313 may output a second latent feature LF2 based on the Mel-spectrogram. The third feature encoder 315 may output a third latent feature LF3 based on the STF, and the fourth feature encoder 317 may output a fourth latent feature LF4 based on the MFCC.

In an embodiment, each of the first to fourth feature encoders 311, 313, 315, and 317 may output a corresponding part of the plurality of latent features LFs using a corresponding model. For example, the first feature encoder 311 may utilize a first learning model 312, and the second feature encoder 313 may utilize a CNN (Convolutional Neural Network) model 314. The third feature encoder 315 and the fourth feature encoder 317 may utilize CNN-LSTM (CNN-Long Short-Term Memory) models 316 and 318.

For example, the first learning model 312 may include large pre-trained models such as Wav2Vec2.0 and HuBERT models. The first learning model 312 may be generated by utilizing a large amount of unlabeled data, and may train more powerful representations compared to models trained by utilizing labeled data.

For example, the CNN model 314 and the CNN-LSTM models 316 and 318 may be artificial neural network models using deep learning technology. By using deep learning technology, various features may be automatically extracted directly from a speech signal without manual work.

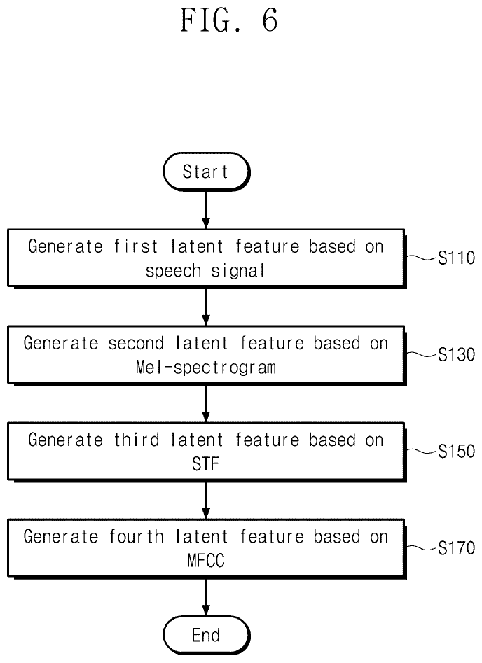

FIG. 6 is a flowchart illustrating an embodiment of an operation of an encoder layer of FIG. 5.

Referring to FIG. 6, in an operation in which an encoder layer outputs the plurality of latent features, a first latent feature may be generated based on a speech signal (S110).

A second latent feature may be generated based on a Mel-spectrogram (S130).

A third latent feature may be generated based on an STF (S150).

A fourth latent feature may be generated based on an MFCC (S170).

In an embodiment, S110, S130, S150, and S170 may be processed in parallel, and the parallel processing may contribute to improving the accuracy of the speech emotion recognition apparatus according to embodiments of the present disclosure.

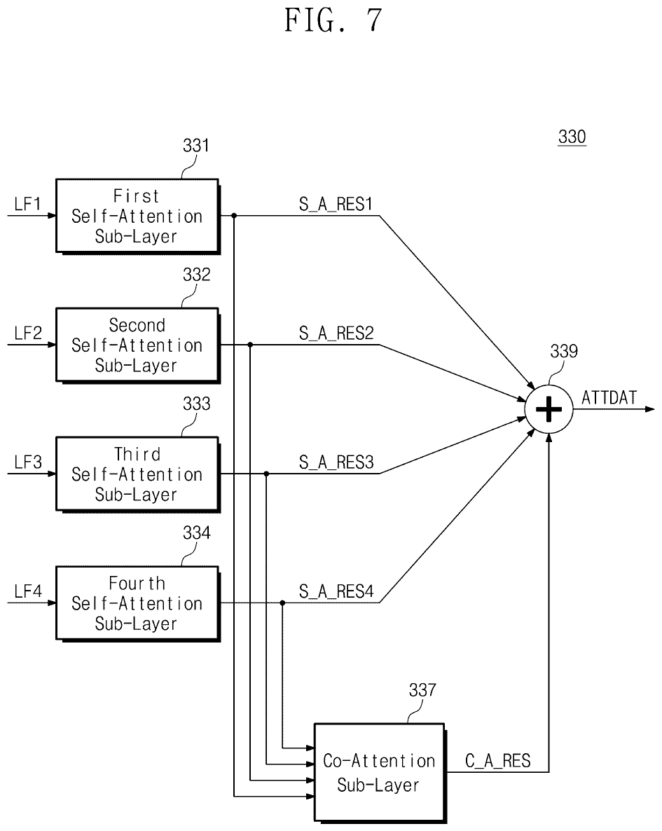

FIG. 7 is a block diagram illustrating an embodiment of an attention layer of FIG. 4.

Referring to FIG. 7, the attention layer 330 may include a first self-attention sub-layer 331, a second self-attention sub-layer 332, a third self-attention sub-layer 333, a fourth self-attention sub-layer 334, a co-attention sub-layer 337, and a matrix concatenator 339. Although FIG. 7 illustrates an embodiment in which the attention layer 330 includes four self-attention sub-layers, the number and types of the self-attention sub-layers are only examples. For example, the number of self-attention sub-layers may be the same as the number of all of the speech signal and pre-processed signal described above with reference to FIG. 5, or the number of feature encoders, but the scope of the present disclosure is not limited thereto.

The first self-attention sub-layer 331 may generate a first self-attention result value S_A_RES1 based on the first latent feature LF1, and the second self-attention sub-layer 332 may generate a second self-attention result value S_A_RES2 based on the second latent feature LF2. The third self-attention sub-layer 333 may generate a third self-attention result value S_A_RES3 based on the third latent feature LF3, and the fourth self-attention sub-layer 334 may generate a fourth self-attention result value S_A_RES4 based on the fourth latent feature LF4.

The co-attention sub-layer 337 may generate a co-attention result value C_A_RES based on the first to fourth self-attention result values S_A_RES1, S_A_RES2, S_A_RES3, and S_A_RES4.

The matrix concatenator 339 may generate the attention data ATTDAT by concatenating the first to fourth self-attention result values S_A_RES1, S_A_RES2, S_A_RES3, and S_A_RES4 and the co-attention result value C_A_RES.

In an embodiment, the attention layer 330 may include the plurality of self-attention sub-layers (e.g., 331, 332, 333, and 334) and the co-attention sub-layer (e.g., 337), wherein the plurality of self-attention sub-layers may generate a plurality of self-attention result values corresponding to a plurality of latent features, respectively, and the co-attention sub-layer may generate a co-attention result value corresponding to all of the plurality of latent features.

In an embodiment, the attention layer 330 may efficiently analyze and identify a relationship or interdependence between a speech signal and a pre-processed signal by focusing on a specific part (particularly, a part where an emotion change is most salient) of the speech signal or the pre-processed signal using the plurality of self-attention sub-layers and the co-attention sub-layer.

In an embodiment, each of the plurality of self-attention sub-layers may focus on a specific part of a corresponding signal among the speech signal and the pre-processed signal using corresponding latent features, and the co-attention sub-layer may focus on a specific part of all of the speech signal and pre-processed signal using all of the plurality of self-attention result values output from the plurality of self-attention sub-layers.

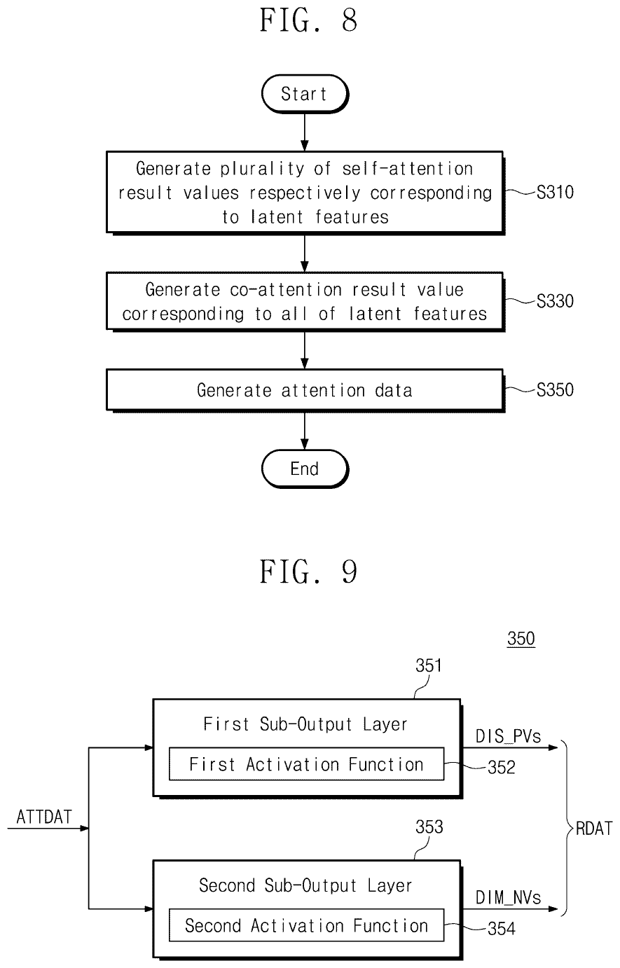

FIG. 8 is a flowchart illustrating an embodiment of an operation of an attention layer of FIG. 7.

Referring to FIG. 8, in operation where the attention layer outputs attention data, a plurality of self-attention result values respectively corresponding to a plurality of latent features may be generated (S310).

In an embodiment, a self-attention mechanism may be applied to the latent features to calculate the plurality of self-attention result values.

A co-attention result value corresponding to all of the latent features may be generated (S330).

In an embodiment, a co-attention mechanism may be applied to the plurality of self-attention result values to calculate the co-attention result value.

The attention data may be generated by concatenating the plurality of self-attention result values and the co-attention result value (S350).

FIG. 9 is a block diagram illustrating an embodiment of an output layer of FIG. 5.

Referring to FIG. 9, the output layer 350 may include a first sub-output layer 351 and a second sub-output layer 353.

The first sub-output layer 351 may generate the probability values DIS_PVs associated with the discrete emotional representations based on the attention data ATTDAT. The second sub-output layer 353 may generate the numerical values DIM_NVs associated with the dimensional emotional representations based on the attention data ATTDAT. The probability values DIS_PVs and the numerical values DIM_NVs may be included in the result data RDAT of the speech emotion recognition apparatus according to embodiments of the present disclosure.

In an embodiment, the first and second sub-output layers 351 and 353 may output the result data RDAT using a corresponding activation function. For example, the first sub-output layer 351 may use a first activation function 352, and the second sub-output layer 353 may use a second activation function 354. For example, the first sub-output layer 351 may calculate the probability values DIS_PVs associated with the discrete emotional representations based on the first activation function 352, and the second sub-output layer 353 may calculate the numerical values DIM_NVs associated with the dimensional emotional representations based on the second activation function 354.

In an embodiment, the first activation function 352 may include a softmax function, and the second activation function 354 may include a linear activation function.

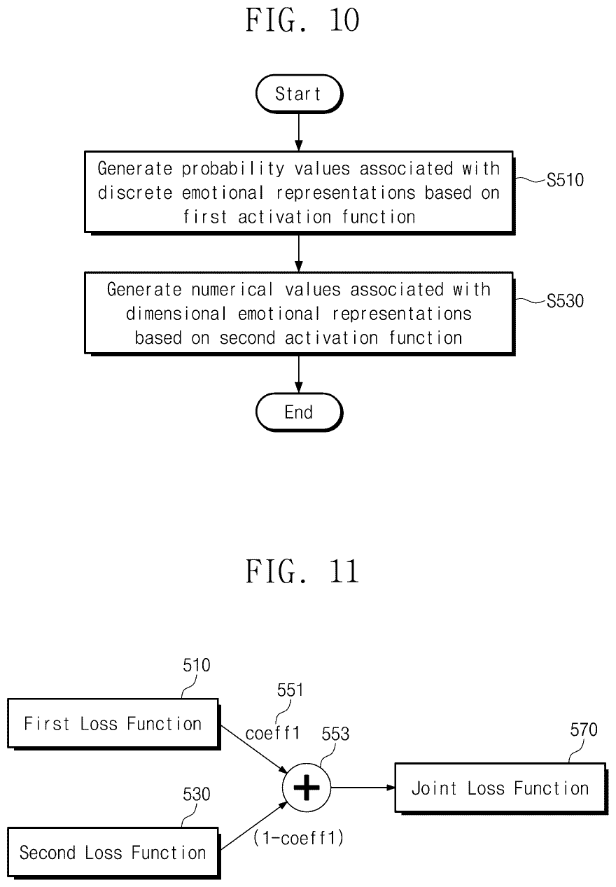

FIG. 10 is a flowchart illustrating an embodiment of an operation of an output layer of FIG. 9.

Referring to FIG. 10, in the process of outputting the result data by the output layer, probability values associated with discrete emotional representations may be generated based on the first activation function (S510).

Numerical values associated with dimensional emotional representations may be generated based on the second activation function (S530).

FIG. 11 is a diagram for describing a joint loss function related to training of an artificial neural network model of FIG. 1.

Referring to FIG. 11, the artificial neural network model (e.g., 131 of FIG. 1 or 300 of FIG. 3) may be trained by the processor (e.g., 110 of FIG. 1).

In an embodiment, a first loss function 510 may be defined to train parameters included in layers (e.g., an encoder layer, an attention layer, and an output layer) of an artificial neural network model for outputting probability values associated with the discrete emotional representations, as described above with reference to FIG. 1 and FIG. 2, and a second loss function 530 may be defined to train parameters of layers of the artificial neural network model for outputting numerical values associated with the dimensional emotional representations. For example, the first loss function 510 is for the classification task of the discrete emotional representations and may be referred to as a ‘categorical loss function’, and the second loss function 530 is for the regression task of the dimensional emotional representations and may be referred to as a ‘regression loss function’.

In an embodiment, the processor may generate a joint loss function 570 based on the first loss function 510 related to the discrete emotional representations and the second loss function 530 related to the dimensional emotional representations, and may train the artificial neural network model based on the joint loss function 570. For example, using the joint loss function 570, the processor may simultaneously train the classification task of the discrete emotional representations and the regression task of the dimensional emotional representations. Such simultaneous training may contribute to improving the performance of the artificial neural network model by utilizing and supplementing the relationship between the classification task and the regression task.

In an embodiment, the processor may perform matrix addition 553 on the first loss function 510 and the second loss function 530 based on a first coefficient 551 to generate the joint loss function 570.

In an embodiment, the processor may update the first coefficient 551 per epoch related to training of the artificial neural network model based on one of a uniform weighting method, a task-specific weighting method, a dynamic weighting method, and a joint weighting method.

For example, the uniform weighting method may mean a method of assigning the same weight to the first loss function 510 and the second loss function 530, and the task-specific weighting method may mean a method of determining weights depending on the importance of tasks corresponding to the first loss function 510 and the second loss function 530 or the characteristics of a data set for training. The dynamic weighting method may mean a method of updating weights based on model performance for the tasks corresponding to the first loss function 510 and the second loss function 530, respectively, and the joint weighting method may mean a method of updating by including weights in the gradient calculation of a gradient descent method at each epoch related to training of the artificial neural network model, which is similar to the dynamic weighting method.

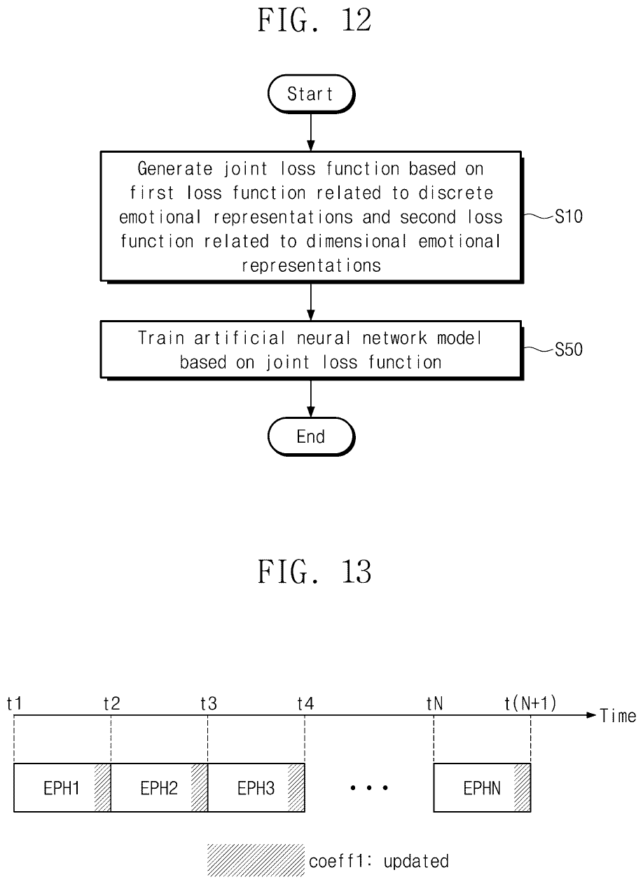

FIG. 12 is a flowchart illustrating an embodiment of a process for training an artificial neural network model of FIG. 1 based on a joint loss function of FIG. 11.

Referring to FIG. 12, in the process of training an artificial neural network model, a joint loss function may be generated based on a first loss function related to the discrete emotional representations and a second loss function related to the dimensional emotional representations (S10).

The artificial neural network model may be trained based on the joint loss function (S50).

FIG. 13 is a diagram for describing a process for updating a first coefficient of FIG. 11.

In FIG. 13, when the artificial neural network model is implemented using a deep learning artificial neural network, an embodiment is illustrated in which a plurality of epochs EPH1, EPH2, EPH3, . . . , and EPHN (where “N” is an integer greater than or equal to 5) are sequentially performed as time points t1, t2, t3, t4, . . . , tN, and t(N+1) elapse.

Referring to FIG. 11 and FIG. 13, the artificial neural network model may be trained by the processor (e.g., 131 of FIG. 1 or 300 of FIG. 3), and the processor may update a first coefficient ‘coeff1’ for each epoch. The artificial neural network models of FIG. 1 and FIG. 4 may be trained depending on various weighting methods by updating the first coefficient ‘coeff1’.

The above-described single joint loss function and the above-described various weighting methods with reference to FIGS. 11 to 13 may further contribute to improving the accuracy of the speech emotion recognition apparatus according to the embodiments of the present disclosure, together with the above-described parallel processing with reference to FIGS. 1 and 6.

As described above, the speech emotion recognition apparatus according to the embodiments of the present disclosure may analyze and integrate the discrete and dimensional aspects of the speaker's emotion and may represent the result data including probability values associated with the discrete emotional representations and numerical values associated with the dimensional emotional representations. The speech emotion recognition apparatus may improve the accuracy of speech emotion recognition by concatenating discrete emotional representations and dimensional emotional representations to provide a more comprehensive and subtle understanding with respect to the speaker's emotion. The speech emotion recognition apparatus may provide an integrated model architecture that enables simultaneous learning of a classification task related to the discrete emotional representations and a regression task related to the dimensional emotional representations, and may provide a comprehensive understanding with respect to the speaker's emotion and may improve interpretability by using the integrated model architecture.

The terms “unit”, “module”, etc. used in the present disclosure or the functional blocks illustrated in the drawings may be implemented in the form of a software component, a hardware component, or a combination thereof. Accordingly, the preprocessing module and the interface module of FIG. 1 may be implemented as, for example, a ‘preprocessing circuit’ and an ‘interface circuit’, respectively.

According to an embodiment of the present disclosure, the speech emotion recognition apparatus may analyze and integrate the discrete and dimensional aspects of the speaker's emotion, and may represent the speaker's emotion as result data including probability values associated with discrete emotional representations and numerical values associated with dimensional emotional representations. The speech emotion recognition apparatus may improve the accuracy of speech emotion recognition by concatenating discrete emotional representations and dimensional emotional representations to provide a more comprehensive and subtle understanding with respect to the speaker's emotion. The speech emotion recognition apparatus may provide an integrated model architecture that enables simultaneous learning of a classification task related to the discrete emotional representations and a regression task related to the dimensional emotional representations, and may provide a comprehensive understanding with respect to the speaker's emotion and may improve interpretability by using the integrated model architecture.

The above descriptions are detail embodiments for carrying out the present disclosure. Embodiments in which a design is changed simply or which are easily changed may be included in the present disclosure as well as an embodiment described above. In addition, technologies that are easily changed and implemented by using the above embodiments may be included in the present disclosure. Therefore, the scope of the present disclosure should not be limited to the above-described embodiments and should be defined by not only the claims to be described later, but also those equivalent to the claims of the present disclosure.

What is claimed is:

1. A speech emotion recognition apparatus comprising:
a processor configured to receive a speech signal and to generate result data derived from the speech signal using an artificial neural network model, and
wherein the artificial neural network model includes:
an encoder layer configured to output a plurality of latent features based on the speech signal and a pre-processed signal obtained by preprocessing the speech signal;
an attention layer configured to output attention data by applying a self-attention mechanism and a co-attention mechanism to the plurality of latent features; and
an output layer configured to output the result data including probability values associated with discrete emotional representations and numerical values associated with dimensional emotional representations based on the attention data.

2. The speech emotion recognition apparatus of claim 1, wherein the encoder layer includes a plurality of feature encoders,
wherein some of the feature encoders are configured to generate some of the plurality of latent features based on the speech signal, and
wherein others of the feature encoders are configured to generate other some of the plurality of latent features based on the speech signal or the pre-processed signal.

3. The speech emotion recognition apparatus of claim 2, wherein the pre-processed signal includes a Mel-spectrogram, an STF (short-term feature), and MFCC (Mel-Frequency Cepstral Coefficients), which are related to the speech signal.

4. The speech emotion recognition apparatus of claim 3, wherein the plurality of latent features include a first latent feature, a second latent feature, a third latent feature, and a fourth latent feature, and
wherein the plurality of feature encoders include:
a first feature encoder configured to generate the first latent feature based on the speech signal;
a second feature encoder configured to generate the second latent feature based on the Mel-spectrogram;
a third feature encoder configured to generate the third latent feature based on the STF; and
a fourth feature encoder configured to generate the fourth latent feature based on the MFCC.

5. The speech emotion recognition apparatus of claim 4, wherein the first feature encoder is configured to use a first learning model,
wherein the second feature encoder is configured to use a CNN (Convolutional Neural Network) model, and
wherein each of the third feature encoder and the fourth feature encoder is configured to use a CNN-LSTM (CNN-Long Short-Term Memory) model.

6. The speech emotion recognition apparatus of claim 1, wherein the attention layer includes:
a plurality of self-attention sub-layers configured to generate a plurality of self-attention result values respectively corresponding to the plurality of latent features; and
a co-attention sub-layer configured to generate a co-attention result value corresponding to all of the plurality of latent features.

7. The speech emotion recognition apparatus of claim 6, wherein the encoder layer is configured to provide the plurality of latent features to the plurality of self-attention sub-layers, and
wherein the plurality of self-attention sub-layers are configured to provide the plurality of self-attention result values to the co-attention sub-layer.

8. The speech emotion recognition apparatus of claim 7, wherein the attention layer further includes a matrix concatenator configured to concatenate the plurality of self-attention result values and the co-attention result value to generate the attention data.

9. The speech emotion recognition apparatus of claim 1, wherein the output layer includes:
a first sub-output layer configured to generate the probability values associated with the discrete emotional representations; and
a second sub-output layer configured to generate the numerical values associated with the dimensional emotional representations.

10. The speech emotion recognition apparatus of claim 9, wherein the first sub-output layer is configured to calculate the probability values associated with the discrete emotional representations based on a first activation function, and
wherein the second sub-output layer is configured to calculate the numerical values associated with the dimensional emotional representations based on a second activation function.

11. The speech emotion recognition apparatus of claim 10, wherein the first activation function includes a softmax function, and
wherein the second activation function includes a linear function.

12. The speech emotion recognition apparatus of claim 1, wherein the processor is configured to:
generate a joint loss function based on a first loss function associated with the discrete emotional representations and a second loss function associated with the dimensional emotional representations; and
train the artificial neural network model based on the joint loss function.

13. The speech emotion recognition apparatus of claim 12, wherein the processor is configured to, based on a first coefficient, perform a matrix addition of the first loss function and the second loss function to generate the joint loss function.

14. The speech emotion recognition apparatus of claim 13, wherein the processor updates the first coefficient at each epoch associated with the training of the artificial neural network model based on one of a uniform weighting method, a task-specific weighting method, a dynamic weighting method, and a joint weighting method.

15. A speech emotion recognition method using an artificial neural network model, the method comprising:
outputting a plurality of latent features based on a speech signal;
outputting attention data by applying a self-attention mechanism and a co-attention mechanism to the plurality of latent features; and
outputting result data including probability values associated with discrete emotional representations and numerical values associated with dimensional emotional representations based on the attention data.

16. The method of claim 15, wherein the plurality of latent features include a first latent feature, a second latent feature, a third latent feature, and a fourth latent feature, and
wherein the outputting of the plurality of latent features includes:
generating the first latent feature based on the speech signal;
generating the second latent feature based on a Mel-spectrogram associated with the speech signal;
generating the third latent feature based on an STF associated with the speech signal; and
generating the fourth latent feature based on an MFCC associated with the speech signal.

17. The method of claim 15, wherein the outputting of the attention data includes:
generating a plurality of self-attention result values respectively corresponding to the plurality of latent features;
generating a co-attention result value corresponding to all of the latent features; and
generating the attention data by concatenating the plurality of self-attention result values and the co-attention result value.

18. The method of claim 17, wherein the generating of the plurality of self-attention result values includes calculating the plurality of self-attention result values by applying a self-attention mechanism to the latent features, and
wherein the generating of the co-attention result value includes calculating the co-attention result value by applying a co-attention mechanism to the plurality of self-attention result values.

19. The method of claim 15, wherein the outputting of the result data includes:
generating the probability values associated with the discrete emotional representations based on a first activation function; and
generating the numerical values associated with the dimensional emotional representations based on a second activation function.

20. The method of claim 15, further comprising:
generating a joint loss function based on a first loss function associated with the discrete emotional representations and a second loss function associated with the dimensional emotional representations; and
training the artificial neural network model based on the joint loss function.
